(19) United States
(12) Patent Application Publication
(10) Pub. No.: US 2026/0062140 A1
(43) Pub. Date: Mar. 5, 2026

(54) PRESCRIPTIVE ALERTING FOR AIRCRAFT COMPONENT FAULT PREDICTIONS

(71) Applicant: THE BOEING COMPANY, Arlington, VA (US)

(72) Inventors: Changzhou WANG, Bellevue, WA (US); Baoqian WANG, Madison, AL (US)

(21) Appl. No.: 18/923,319

(22) Filed: Oct. 22, 2024

Related U.S. Application Data
(60) Provisional application No. 63/689,454, filed on Aug. 30, 2024.

(51) Int. Cl. B64D 45/00

(52) U.S. Cl. CPC B64D 45/00; B64D 2045/0085

(57) ABSTRACT

The present disclosure provides a method including: receiving flight sensor data and component fault data corresponding to a plurality of flights; applying a predictive model to individual flights of the plurality of flights to generate a plurality of fault probabilities for at least one aircraft component; selecting, based on a factor indicating a tolerance of false alerts, a plurality of settings comprising a minimum count of flights, a threshold probability, one or more detection window settings, and one or more alert group settings; detecting, based on the one or more detection window settings, a condition that at least the minimum count of flights within a detection window have a respective fault probability, of the plurality of fault probabilities, that is greater than the threshold probability; and determining, based on the one or more alert group settings, whether to generate a new alert for the condition.

### CROSS-REFERENCE TO RELATED APPLICATION

This application claims benefit of U.S. Provisional patent application Ser. No. 63/689,454, filed Aug. 30, 2024, which is incorporated herein by reference in its entirety.

### FIELD

Aspects of the present disclosure relate to aircraft maintenance, and more specifically, to techniques for generating alerts for predicted aircraft component faults.

### BACKGROUND

The accurate prediction of aircraft component faults contributes to the safety, efficiency, and reliability of aviation operations. By accurately predicting when and how components might generate a fault, component degradation can be detected earlier to enable maintenance teams to perform timely interventions, replacing or repairing parts before they reach a fault condition. These interventions may be effective to prevent more severe damage and reduce repair costs. This proactive approach can optimize the maintenance schedule, which reduces downtime and operational costs to the airlines.

In addition to improved safety and operational efficiency, the accurate prediction of aircraft component faults has significant economic benefits. It minimizes the unexpected grounding of aircraft, which disrupts flight schedules and often leads to financial losses for airlines. Predictive maintenance allows airlines to plan maintenance activities during scheduled downtimes, thereby maintaining the optimal availability of the fleet.

### SUMMARY

The present disclosure provides a method in one aspect, the method including: receiving flight sensor data and component fault data corresponding to a plurality of flights; applying a predictive model to individual flights of the plurality of flights to generate a plurality of fault probabilities for at least one aircraft component; selecting, based on a factor indicating a tolerance of false alerts, a plurality of settings including a minimum count of flights, a threshold probability, one or more detection window settings, and one or more alert group settings; detecting, based on the one or more detection window settings, a condition that at least the minimum count of flights within a detection window have a respective fault probability, of the plurality of fault probabilities, that is greater than the threshold probability; and determining, based on the one or more alert group settings, whether to generate a new alert for the condition.

In one aspect, in combination with any example method above or below, the method further includes: determining, using inspection data, a count of false alerts for the aircraft component; and selecting the factor using the count of false alerts.

In one aspect, in combination with any example method above or below, the method further includes: receiving inspection data for the aircraft component, wherein the plurality of settings further includes one or more inspection settings, and wherein determining whether to generate the new alert for the condition is based on the inspection data.

In one aspect, in combination with any example method above or below, wherein determining whether to generate the new alert for the condition includes: when no previous alert exists for the aircraft component, generating an alert group and the new alert for the condition; when a current runtime is within an inspection interval of a previous alert, awaiting an inspection result in the inspection data for the previous alert; when an inspection result of the inspection data indicates that the aircraft component should be repaired or replaced, determining to not generate the new alert; when the current runtime is at least a group gap setting after a time of the previous alert and a time of the inspection result, and a count of alert groups is less than a maximum group count, generating an alert group and the new alert for the condition; and when a count of alerts in a current alert group is less than a group size, and the current runtime is at least a suppress windows setting that is based on the count of alerts, generating the new alert for the condition.

In one aspect, in combination with any example method above or below, the method further includes: determining an optimal combination of the one or more detection window settings, which includes, for individual combinations of a plurality of combinations: for individual records of the flight sensor data and the component fault data, assigning arrival times to the individual records according to at least a first probability distribution; simulating a plurality of iterations for the individual combination, each iteration including: generating inspection data according to at least a second probability distribution; and generating alerts based on the inspection data; and determining the factor based on the generated alerts.

In one aspect, in combination with any example method above or below, wherein the at least a first probability distribution includes one or more of the following: a probability distribution representing a generalized data delay; and a probability distribution representing out-of-sequence data arrivals.

In one aspect, in combination with any example method above or below, wherein the at least a second probability distribution includes one or more of the following: a probability distribution representing whether an inspection will be scheduled; a probability distribution representing a time that the inspection will be scheduled; a probability distribution representing whether the component will pass the inspection; and a probability distribution representing a communication delay from the alerts.

The present disclosure provides a computer program product in one aspect, the computer program product including: a computer-readable storage medium having computer-readable program code embodied therewith, the computer-readable program code executable by one or more computer processors to perform an operation including: receiving flight sensor data and component fault data corresponding to a plurality of flights; applying a predictive model to individual flights of the plurality of flights to generate a plurality of fault probabilities for at least one aircraft component; selecting, based on a factor indicating a tolerance of false alerts, a plurality of settings including a minimum count of flights, a threshold probability, one or more detection window settings, and one or more alert group settings; detecting, based on the one or more detection window settings, a condition that at least the minimum count of flights within a detection window have a respective fault probability, of the plurality of fault probabilities, that is greater than the threshold probability; and determining, based on the one or more alert group settings, whether to generate a new alert for the condition.

In one aspect, in combination with any example computer program product above or below, the operation further includes: determining, using inspection data, a count of false alerts for the aircraft component; and selecting the factor using the count of false alerts.

In one aspect, in combination with any example computer program product above or below, the operation further includes: receiving inspection data for the aircraft component, wherein the plurality of settings further includes one or more inspection settings, and wherein determining whether to generate the new alert for the condition is based on the inspection data.

In one aspect, in combination with any example computer program product above or below, wherein determining whether to generate the new alert for the condition includes: when no previous alert exists for the aircraft component, generating an alert group and the new alert for the condition; when a current runtime is within an inspection interval of a previous alert, awaiting an inspection result in the inspection data for the previous alert; when an inspection result of the inspection data indicates that the aircraft component should be repaired or replaced, determining to not generate the new alert; when the current runtime is at least a group gap setting after a time of the previous alert and a time of the inspection result, and a count of alert groups is less than a maximum group count, generating an alert group and the new alert for the condition; and when a count of alerts in a current alert group is less than a group size, and the current runtime is at least a suppress windows setting that is based on the count of alerts, generating the new alert for the condition.

In one aspect, in combination with any example computer program product above or below, the operation further includes: determining an optimal combination of the one or more detection window settings, which includes, for individual combinations of a plurality of combinations: for individual records of the flight sensor data and the component fault data, assigning arrival times to the individual records according to at least a first probability distribution; simulating a plurality of iterations for the individual combination, each iteration including: generating inspection data according to at least a second probability distribution; and generating alerts based on the inspection data; and determining the factor based on the generated alerts.

In one aspect, in combination with any example computer program product above or below, wherein the at least a first probability distribution includes one or more of the following: a probability distribution representing a generalized data delay; and a probability distribution representing out-of-sequence data arrivals.

In one aspect, in combination with any example computer program product above or below, wherein the at least a second probability distribution includes one or more of the following: a probability distribution representing whether an inspection will be scheduled; a probability distribution representing a time that the inspection will be scheduled; a probability distribution representing whether the component will pass the inspection; and a probability distribution representing a communication delay from the alerts.

The present disclosure provides a system in one aspect, the system including: one or more processors; and a memory storing instructions that when executed by the one or more processors enable performance of an operation including: receiving flight sensor data and component fault data corresponding to a plurality of flights; applying a predictive model to individual flights of the plurality of flights to generate a plurality of fault probabilities for at least one aircraft component; selecting, based on a factor indicating a tolerance of false alerts, a plurality of settings including a minimum count of flights, a threshold probability, one or more detection window settings, and one or more alert group settings; detecting, based on the one or more detection window settings, a condition that at least the minimum count of flights within a detection window have a respective fault probability, of the plurality of fault probabilities, that is greater than the threshold probability; and determining, based on the one or more alert group settings, whether to generate a new alert for the condition.

In one aspect, in combination with any example system above or below, the operation further includes: determining, using inspection data, a count of false alerts for the aircraft component; and selecting the factor using the count of false alerts.

In one aspect, in combination with any example system above or below, the operation further includes: receiving inspection data for the aircraft component, wherein the plurality of settings further includes one or more inspection settings, and wherein determining whether to generate the new alert for the condition is based on the inspection data.

In one aspect, in combination with any example system above or below, wherein determining whether to generate the new alert for the condition includes: when no previous alert exists for the aircraft component, generating an alert group and the new alert for the condition; when a current runtime is within an inspection interval of a previous alert, awaiting an inspection result in the inspection data for the previous alert; when an inspection result of the inspection data indicates that the aircraft component should be repaired or replaced, determining to not generate the new alert; when the current run time is at least a group gap setting after a time of the previous alert and a time of the inspection result, and a count of alert groups is less than a maximum group count, generating an alert group and the new alert for the condition; and when a count of alerts in a current alert group is less than a group size, and the current run time is at least a suppress windows setting that is based on the count of alerts, generating the new alert for the condition.

In one aspect, in combination with any example system above or below, the operation further includes: determining an optimal combination of the one or more detection window settings, which includes, for individual combinations of a plurality of combinations: for individual records of the flight sensor data and the component fault data, assigning arrival times to the individual records according to at least a first probability distribution; simulating a plurality of iterations for the individual combination, each iteration including: generating inspection data according to at least a second probability distribution; and generating alerts based on the inspection data; and determining the factor based on the generated alerts.

In one aspect, in combination with any example system above or below, wherein the at least a first probability distribution includes one or more of the following: a probability distribution representing a generalized data delay; and a probability distribution representing out-of-sequence data arrivals.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts an example system of generating alerts based on flight-level predictions, according to one or more aspects.

FIG. 2 depicts an example method of generating alerts based on flight-level predictions, according to one or more aspects.

FIG. 3 depicts an example method of determining an optimal combination of a plurality of settings for aggregating flight-level predictions, according to one or more aspects.

FIG. 4 depicts plots of aggregating flight-level predictions to generate alerts, according to one or more aspects.

### DETAILED DESCRIPTION

Predictive models for component faults often provide flight-level predictions (that is, a fault prediction is calculated for an individual flight). For example, a predictive model may predict whether a fault of an aircraft component will occur within 30 days of a particular flight, using information representing all previous flights of the same aircraft since component installation, or using previous flights of all aircraft in which the component was installed (e.g., the component was removed and repaired multiple times).

The flight-level predictions of the predictive models can be inconsistent, with predictions alternating between fault indications and no-fault indications in consecutive flights. Metrics that are derived from the flight-level predictions (e.g., precision and recall) can be misleading in evaluating the predictive models. For example, customers when assessing performance of the predictive model tend to focus on counts of alerts, failures, and/or removals, instead of individual flights. Further, commonly-used metrics tend to disregard early predictions, to penalize partial predictions, and to equate the effects of scattered false positives (fault indications) with consecutive false positives.

According to aspects described herein, a predictive model may be applied to the flight sensor data and component fault data for individual flights to generate fault probabilities for an aircraft component. A factor indicating a tolerance of false alerts is used to select a plurality of settings, which are used to assess the fault probabilities and determine whether to generate new alerts therefore.

Generally, it can be challenging for customers to interpret individual predictions and take appropriate maintenance actions (e.g., inspect, clean, repair, replace), especially for large numbers of positive predictions and when the relationship between the predictions is not well-understood. Conventionally, human experts may be used to develop heuristics to address the individual predictions. However, human experts tend to exhibit bias toward recent and peak experiences, and may further drift over time. Beneficially, aspects described herein include aggregating the flight-level predictions to generate improved alerts with prescribed maintenance actions that are more helpful to customers.

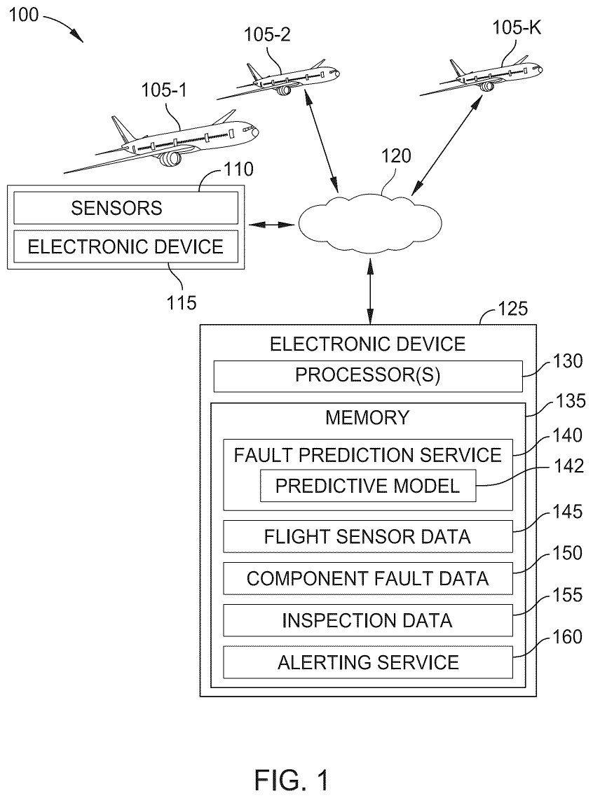

FIG. 1 depicts an example system 100 of generating alerts based on flight-level predictions, according to one or more aspects. The features described with respect to FIG. 1 may be used in conjunction with other aspects. Further, although the description is directed to aircraft maintenance, the techniques described herein may be applied to other industries that use preventative maintenance on components.

The system 100 comprises a plurality of aircraft 105-1, 105-2, . . . , 105-K (also referred to individually or collectively as aircraft 105) having any suitable type(s) and/or configuration(s). Each aircraft 105 comprises a respective plurality of sensors 110 that are communicatively coupled with at least one electronic device 115, as would be understood by the person of ordinary skill. As used herein, an “electronic device” generally refers to any device having electronic circuitry that provides a processing or computing capability, and that implements logic and/or executes program code to perform various operations that collectively define the functionality of the electronic device. The functionality of the electronic device includes a communicative capability with one or more other electronic devices, e.g., when connected to a same network. An electronic device may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any of a number of suitable techniques, such as conductive cabling, wireless transmission, optical transmission, and so forth. Further, although described as being performed by a single electronic device, in other aspects, the functionalities of the system 100 may be performed by a plurality of electronic devices.

The sensors 110 may be operated to monitor various components of the aircraft 105. The sensors 110 may be implemented in any suitable form, such as discrete sensor devices, sensor hardware that is fully or partly integrated into the components, or processors or other circuitry that supplies information that can be used for diagnostic and/or maintenance purposes. Some non-limiting examples of the sensors 110 include vibration sensors (e.g., accelerometers), temperature sensors (e.g., thermocouples, infrared sensors), pressure sensors (e.g., piezoelectric, capacitive, or strain gauge-based), fluid quality sensors (e.g., optical sensors, capacitive sensors, magnetic particle detectors), load sensors (e.g., strain gauges, load cells), crack detection sensors (e.g., eddy current sensors, ultrasonic sensors), corrosion sensors (e.g., electrical resistance sensors, galvanic sensors), voltage and current sensors (e.g., Hall effect sensors, shunt resistors), flow sensors, humidity sensors, air quality sensors (e.g., chemical sensors, particulate sensors).

The flight sensor data 145 that is acquired by the sensors 110 may be provided to the electronic device 115 in any suitable form (e.g., as analog or digital signals; structured, semi-structured, or unstructured data). In some cases, the electronic device 115 may supply power and/or signals to the sensors 110 to control the operation thereof. The electronic device 115 may be implemented in any suitable form in the aircraft 105, such as a flight management system (FMS) computer, an aircraft condition monitoring system (ACMS) computer, and an environmental control system (ECS) computer, or combinations thereof. The electronic device 115 may be implemented in other forms onboard the aircraft 105, which may include standalone devices.

The electronic devices 115 of the aircraft 105 communicate with at least one other electronic device 125 through a network 120. The network 120 may have any suitable implementation, such as one or more wide area networks (WANs), one or more local access networks (LANs), or combinations thereof. The network 120 comprises infrastructure for communicative capability, such as conductive cabling, wireless transmission, optical transmission, and so forth. The network 120 may further comprise one or more electronic devices providing network functionality and/or services to the network 120, such as routers, firewalls, switches, gateway computers, edge servers, and so forth.

In some aspects, the electronic devices 115 are configured to communicate with the electronic device 125 during flight operations of the respective aircraft 105 (e.g., through wireless communications). In other aspects, and in addition to or alternate to communications during flight operations, the electronic devices 115 are configured to communicate with the electronic device 125 outside of flight operations (e.g., flight sensor data 145 is downloaded through cabling or optical fibers that are connected to the aircraft 105 when stationary, or through wireless communications).

The electronic device 125 comprises one or more processors 130 and a memory 135. The one or more processors 130 are any electronic circuitry, including, but not limited to, one or a combination of microprocessors, microcontrollers, application-specific integrated circuits (ASIC), application-specific instruction set processors (ASIP), and/or state machines, that is/are communicatively coupled to the memory 135 and control(s) the operation of the electronic device 125. The one or more processors 130 are not limited to a single processing device and may encompass multiple processing devices.

The one or more processors 130 may include other hardware that operates software to control and process information. In some aspects, the one or more processors 130 execute software stored in the memory 135 to perform any of the functions described herein. The one or more processors 130 control the operation and administration of the electronic device 125 by processing information (e.g., information received from input devices and/or communicatively coupled electronic devices).

The memory 135 may store, either permanently or temporarily, data, operational software, or other information for the one or more processors 130. The memory 135 may include any one or a combination of volatile or non-volatile local or remote devices suitable for storing information. For example, the memory 135 may include random access memory (RAM), read only memory (ROM), magnetic storage devices, optical storage devices, or any other suitable information storage device or a combination of these devices. The software represents any suitable set of instructions, logic, data, or code embodied in a computer-readable storage medium. For example, the software may be embodied in the memory 135, a disk, a CD, or a flash drive. In particular embodiments, the software may include an application executable by the one or more processors 130 to perform the functionality described herein (e.g., a fault prediction service 140 and an alerting service 160, discussed below).

In this example, the memory 135 stores the fault prediction service 140 that applies a predictive model 142 to the flight sensor data 145 and component fault data 150, to generate fault probabilities for at least one aircraft component. The fault prediction service 140 tracks the fault probabilities for the aircraft component(s), storing the fault probabilities (or characteristics or trends thereof) in the memory 135.

The predictive model 142 may have any suitable implementation. In some aspects, the predictive model 142 may be implemented as a deterministic model. In other aspects, the predictive model 142 may be implemented as a machine learning (ML) model. Some non-limiting examples of the ML model include tree-based regression models (e.g., random forest, xgBoost) with temporal feature extraction methods, or recurrent neural network that directly deal with multivariate time series.

In some aspects, the component fault data 150 is provided by the aircraft 105 through the network 120, and may be explicitly identified as a component fault by the electronic device 115 onboard the aircraft 105, or inferred from anomalous flight sensor data 145. In some aspects, the component fault data 150 may be provided by human operators. For example, pilots or other crew may communicate component malfunctions or faults, maintenance personnel may log component faults after inspection, repair shop testing may provide a mode of component fault, and so forth.

In some aspects, the component fault data 150 includes time information (e.g., when a particular component fault occurred), such as a timestamp or a distinct flight identifier. In some aspects, the component fault data 150 further includes mode information (e.g., how the component fault occurred). In one non-limiting example, the component fault data 150 includes an identifier of the aircraft 105, an installation position, a time, a component part number and serial number, a fault mode, and a repair cost. In another example, the component fault data 150 further includes an installation condition of the component (e.g., repaired or new when installed) and a measure of the usage of the component (e.g., a time, a number of cycles, a number of hours) since the installation.

In some aspects, the fault probabilities are determined by the predictive model 142 at an individual flight level, and are referenced to a specific prediction window (e.g., a fault is predicted to occur within 30 days of the flight). In some aspects, the prediction window may be provided by user input.

The flight sensor data 145 and the component fault data 150 correspond to a plurality of flights. In some aspects, the predictive model 142 uses flight sensor data 145 that represents all previous flights of the same aircraft since installation of the component. In other aspects, the predictive model 142 uses flight sensor data 145 that represents previous flights across all aircraft in which the component was installed (e.g., where the component has been removed or repaired multiple times).

The fault prediction service 140 may apply the predictive model 142 to the flight sensor data 145 and the component fault data 150 in multiple iterations. In some aspects, the fault prediction service 140 applies the predictive model 142 to the flight sensor data 145 and the component fault data 150 periodically (e.g., weekly or monthly). In other aspects, the fault prediction service 140 applies the predictive model 142 to the flight sensor data 145 and the component fault data 150 responsive to receiving flight sensor data 145 that represents new flights (that is, not previously represented in the flight sensor data 145).

In some cases, the flight sensor data 145 and/or the component fault data 150 may be received out-of-order and/or with delay(s). Some examples of delays in the flight sensor data 145 include expected delays (e.g., data acquisition events from an aircraft, transmission network delays, preprocessing from a raw format) and unexpected delays (e.g., aircraft redirected along different routes, errors in the transmission network). The predicted delays need not be identical across all flights, but in some cases may be in accordance with a probability distribution. For example, the flight sensor data 145 may be downloaded from an aircraft only at certain airports, or may be downloaded periodically according to a schedule.

In some aspects, responsive to receiving component fault data 150 indicating that a fault has occurred in a first aircraft component, the fault prediction service 140 stops tracking the fault probabilities for the first aircraft component and begins (or resumes) tracking the fault probabilities for a second aircraft component that replaces the first aircraft component.

The memory 135 further stores the alerting service 160 that receives the fault probabilities from the fault prediction service 140, aggregates the fault probabilities, and determines whether to generate new alerts for a particular condition. In some aspects, the alerting service 160 assigns a priority to generated alerts. Different priority schemes are contemplated, which may include selecting a priority level from several (e.g., two or three) discrete priority levels. In some aspects, the alerting service 160 further provides one or more prescriptive actions (e.g., inspect the component that is possibly faulty, repair the component, replace the component, etc.) with the alert.

The alerting service 160 communicates the alerts to users (e.g., customers) using any suitable techniques, which may include electronic transmission of the alerts to other electronic devices, as well as generating audiovisual prompts. The users may decide whether to schedule an inspection of the component(s) using the indicated priority level, as well as other considerations such as their confidence in the alerts, and any constraints from operations, maintenance, and the supply chain.

In some aspects, the users provide inspection data 155 to the electronic device 125, which may be provided with any suitable formatting. The inspection data 155 may include scheduling data (e.g., indicating whether an inspection has been scheduled) and/or inspection result data (e.g., indicating whether the inspection has been performed, the result of the inspection, and so forth). The inspection result data generally indicates a condition of the component(s) being inspected, and in some cases may be responsive to the possible fault indicated by the alert. In some aspects, the inspection data 155 may provide a positive indication (e.g., a fault, damage, etc. has been found) or a negative indication. Typically, a positive indication results in removal of the particular component. It is possible, given the sometimes limited scope of inspection procedures, that a fault may occur a short time after receiving a negative indication.

In some aspects, the alerting service 160 correlates the inspection data 155 with the generated alerts, and determines one or more performance metrics, such as a percentage of captured faults (e.g., recall), a percentage of false alerts (e.g., precision), and so forth. In some aspects, the different performance metric(s) may be weighted (e.g., based on an estimated operational cost of unexpected faults, an estimated maintenance cost of false alerts, and so forth). In some aspects, the performance metric(s) may reflect an impact of the inspections (e.g., whether the inspection is scheduled or unscheduled, an estimated delay, a success measure, and so forth).

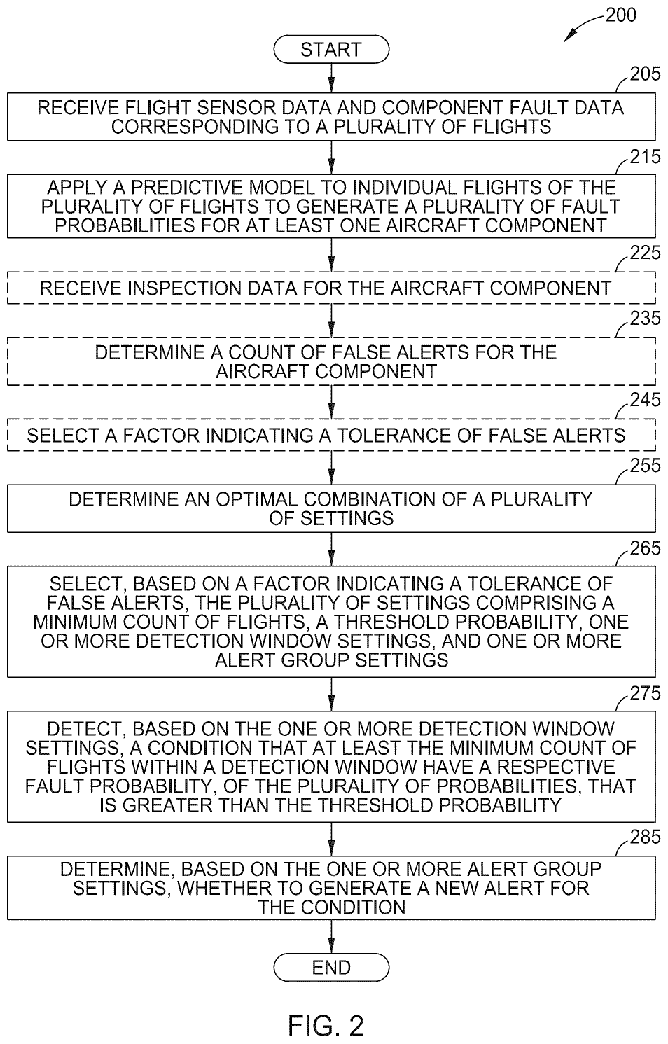

In some aspects, the alerting service 160 may use the one or more performance metrics to trigger an aggregation operation and/or to update the predictive model 142. The aggregation operation includes aggregating flights that are represented in the flight sensor data 145 and/or the component fault data 150. FIG. 2 depicts an example method 200 of generating alerts based on flight-level predictions, according to one or more aspects. The method 200 may be used in conjunction with other aspects. For example, the method 200 may be performed using various components of the electronic device 125, such as the predictive model 142 and the alerting service 160, and may incorporate the aggregation operation.

The method 200 begins at block 205, where the electronic device 125 receives flight sensor data 145 and component fault data 150 corresponding to a plurality of flights. In some aspects, the alerting service 160 performs the aggregation operation periodically (e.g., weekly or monthly). In other aspects, the alerting service 160 performs the aggregation operation responsive to receiving, at block 205, flight sensor data 145 that represents new flights. In some aspects, the alerting service 160 generates alerts at the time of the aggregation operation, although the alerts may be based on earlier flights (e.g., the flight sensor data 145 for the flights arrived only recently, or the flight sensor data 145 has been altered by out-of-sequence flights).

At block 215, the electronic device 125 applies a predictive model 142 to individual flights of the plurality of flights to generate a plurality of fault probabilities P1, . . . , Pn for at least one aircraft component. In some aspects, the plurality of fault probabilities P1, . . . , Pn correspond to each of the n flights having a flight time occurring after a time threshold t. In some aspects, t represents a maximum value (e.g., a latest time) of (1) an earliest flight time for those flights arrived after a previous iteration of the aggregation operation, (2) a last alert time for the same component, and (3) a last inspection feedback time. In some aspects, the alerting service 160 further receives one or more previous alerts for the same component, and inspection data 155 corresponding to the one or more previous alerts.

At an optional block 225, the electronic device 125 receives inspection data 155 for the aircraft component. At an optional block 235, the electronic device 125 determines a count of false alerts N for the aircraft component, which in some aspects is based on the inspection data 155. In some aspects, the electronic device 125 determines the count of false alerts N, a count of true alerts, and a count of faults occurring without alerts. Further, in some aspects, some or all of these values may be further based on the component fault data 150. At an optional block 245, the electronic device 125 selects a factor T indicating a tolerance of false alerts, which in some aspects is based on the count of false alerts. In some aspects, the factor T may represent a tradeoff between missed faults and false alerts, such as a F-measure that combines precision and recall. In some aspects, a user input selects a value of the factor T from a predefined plurality of values corresponding to different F_{β} scores, where β=1 indicates equal weight between precision and recall, β=2 indicates recall is weighted twice in comparison with precision, and β=0.5 indicates precision is weighted twice in comparison with recall.

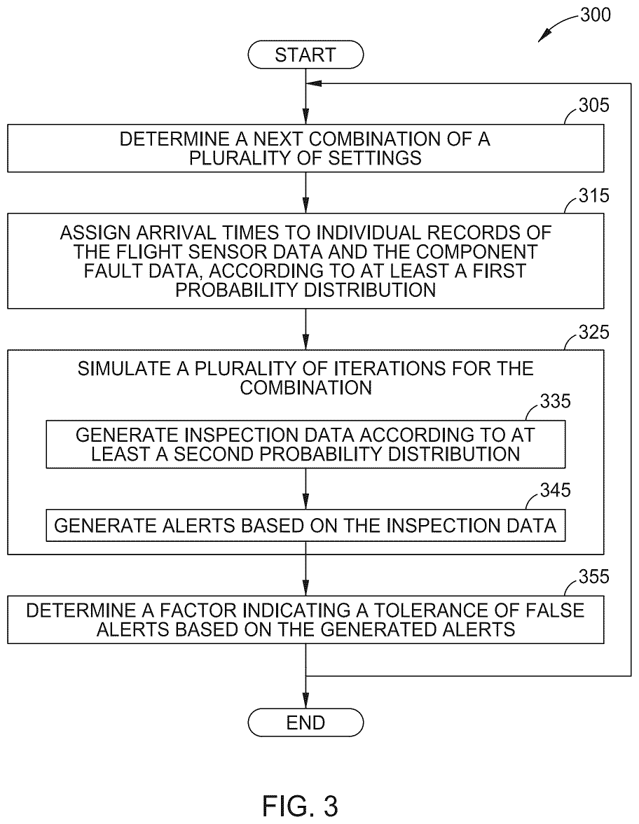

At block 255, the electronic device 125 determines an optimal combination of one or more detection window settings, which will be discussed in greater detail below with respect to FIG. 3. At block 265, the electronic device 125 selects, based on the factor T, a plurality of settings comprising a minimum count of flights, a threshold probability, the one or more detection window settings, and one or more alert group settings. In some aspects, the alerting service 160 uses the plurality of settings as configuration settings for the aggregation operation. The plurality of settings is based on, and in some cases may be indexed to, the factor T and the count of false alerts N. The plurality of settings may be provided with any suitable formatting.

In some aspects, the plurality of settings include setting(s) that are based on maintenance and communication practices, such as an inspection interval setting, an inspection communication minimum time setting (representing a minimum delay from an inspection result), and an inspection communication maximum time setting (representing a maximum delay from an inspection result). The settings may be provided by customers or inferred from customer behaviors, and moreover may be adjusted over time.

In some aspects, the plurality of settings further include some or all of the following:
A ‘detection window’ setting that indicates how quickly the component can fault and how much time a customer needs to respond to an alert. Generally, the value of the detection window setting should be smaller than the prediction window. In some aspects, the range of the detection window ranges from days to weeks.
A “threshold probability” setting with values between 0 and 1. In some aspects, the range of the threshold probability may be narrowed, e.g., between 0.2 and 0.8, to help focus the search for flights.
A “minimum count of flights” setting that depends on the size of the detection window and a stability of the fault probabilities received from the predictive model 142. In some aspects, where component degradation is not demonstrated or expected for flights, the minimum count may be a small number, e.g., between 1 and 5.
A “group size” setting that depends on the prediction window and the suppression window. In some aspects, the values of the group size are a small number, e.g., between 2 and 5.
A “group Gap” Setting That Is Larger Than the Smallest Suppression Window.
A “maximum group count” setting that depends on an expected life of the component, the suppression windows, the group size, and the group gap. In some aspects, if the predictive model 142 performs poorly on some components, the values of the maximum group count fails may be a small number, e.g., between 1 and 3.
A “suppress windows” setting that represents a list of growing suppression window sizes for alerts within the same group. In some aspects, the search space is defined by specifying the first suppression window size (e.g., between 30 and 60 days) and a delta size (e.g., between 0 and 30 days) to add to the previous size for each new suppression window (an additive approach). In other aspects, the search space is defined by specifying the first suppression window size (e.g., between 30 and 60 days) and a growing ratio (e.g., between 1 and 2) to multiply the previous size for each new suppression window. In some aspects, the plurality of settings is determined based on historical flight sensor data 145 and historical component fault data 150, and if any previous alerts have been generated for the component, historical inspection data 155.

At block 275, the electronic device 125 detects, based on the one or more detection window settings, a condition that at least the minimum count of flights within a detection window have a respective fault probability, of the plurality of probabilities, that is greater than the threshold probability.

At block 285, the electronic device 125 determines, based on the one or more alert group settings, whether to generate a new alert for the condition. In one example implementation, determining whether to generate a new alert for the condition comprises: (i) when no previous alert exists for the aircraft component, generating an alert group and the new alert for the condition; (ii) when a current runtime is within the inspection interval of a previous alert, awaiting an inspection result in the inspection data 155 for the previous alert; (iii) when an inspection result of the inspection data 155 indicates that the aircraft component should be repaired or replaced, determining to not generate the new alert; (iv) when the current runtime is at least a group gap setting after a time of the previous alert and a time of the inspection result, and a count of alert groups is less than a maximum group count of the alert group settings, generating an alert group and the new alert for the condition; and (v) when a count of alerts in a current alert group is less than a group size, and the current runtime is at least the suppress windows setting that is based on the count of alerts, generating the new alert for the condition.

Other implementations are also contemplated. In one example, as an alternate to (ii), when the current runtime is earlier than a sum of a target inspection time for the previous alert and the inspection communication minimum time, awaiting the inspection result. In another example, when the current runtime is earlier than a sum of a target inspection time for the previous alert and the inspection communication maximum time, generating a reminder for the inspection result. In another example, as an alternate to (iv), when the count of alert groups equals the maximum group count, determining to not generate the new alert. The method 200 ends following completion of block 285.

FIG. 3 depicts an example method 300 of determining an optimal combination of a plurality of settings for aggregating flight-level predictions, according to one or more aspects. For example, the method 300 represents one example implementation of the block 255, and the plurality of settings may include various settings and types of settings discussed above with respect to block 265.

The method 300 begins at block 305, where the electronic device 125 determines a next combination of the plurality of settings. In some aspects, a first iteration of the combination may be provided by user input (e.g., an estimate of a human expert).

At block 315, the electronic device 125 assigns arrival times to individual records of the flight sensor data and the component fault data, according to at least a first probability distribution. In some aspects, the first probability distribution includes one or both of a data delay probability distribution and an out-of-sequence arrival probability distribution. The data delay probability distribution can depend on a data acquisition process and communication pipeline to the predictive model 142. In one example, data may be downloaded from aircraft only at selected airports, so the arrival airport and/or on-ground time may be inputs to the data delay probability distribution. Generally, the chronological order of the flights may be preserved despite the data delay. The out-of-sequence arrival probability distribution may represent a batch of consecutive flights that are “lost” and later recovered.

At block 325, the electronic device 125 simulates a plurality of iterations for the combination. In some aspects, simulating the plurality of iterations comprises, at block 335, generating inspection data according to at least a second probability distribution.

In some aspects, the second probability distribution includes some or all of an inspection scheduling probability distribution indicating whether a customer will schedule an inspection, an inspection timing probability distribution indicating when the inspection will occur, and an inspection success probability distribution indicating wither the inspection will pass.

The inspection scheduling probability distribution can be provided by customers, or inferred from customers' historical behavior and/or other factors (e.g., seasonal effects, supply chain constraints).

The inspection timing probability distribution may also depend on customer data or behaviors. In some aspects, the inspection timing probability distribution may be integrated with the inspection scheduling probability distribution, e.g., allowing an “infinite” inspection delay to indicate no inspection.

The inspection success probability distribution may depend on the engineering design and manufacturing process of the component. Given historical data with known fault data after the simulated runtime, the inspection success probability distribution may use a time to fault as an example of a key factor. Another example of a factor is a time from alert.

In some aspects, generating the inspection data further comprises estimating a communication delay using a probability distribution similar to the data delay probability distribution, which may be based on customer behaviors and/or communication pipelines.

In some aspects, simulating the plurality of iterations for the combination comprises generating one or more other variables in real-time, such as the list of n flights to check, a number N of passed inspections, a number K of alerts in a current alert group, and all previous alerts (time and group).

In some aspects, simulating the plurality of iterations for the combination comprises, at block 345, generating alerts based on the inspection data. In some aspects, generating alerts is performed according to techniques described above with respect to block 285.

At block 355, the electronic device 125 determines a factor indicating a tolerance of false alerts based on the generated alerts. In some aspects, determining the factor comprises determining, from the plurality of iterations for the combination, a total number of faults (Nf), a total number of alerts (Na), and a number of alerts within the prediction window before the fault (Nt). In some aspects, determining the factor further comprises determining recall (as Nt/Nf), determining precision (as Nt/Na), and determining the F_{β} score.

The method 300 returns from block 355 to block 305, which may be performed for a predefined number of iterations, within a predefined time budget, and so forth. A hyper-parameter tuning algorithm (e.g., random grid searching, Bayesian optimization) may be used to select the best-performing combination of the plurality of settings. The method 300 ends following completion of block 355.

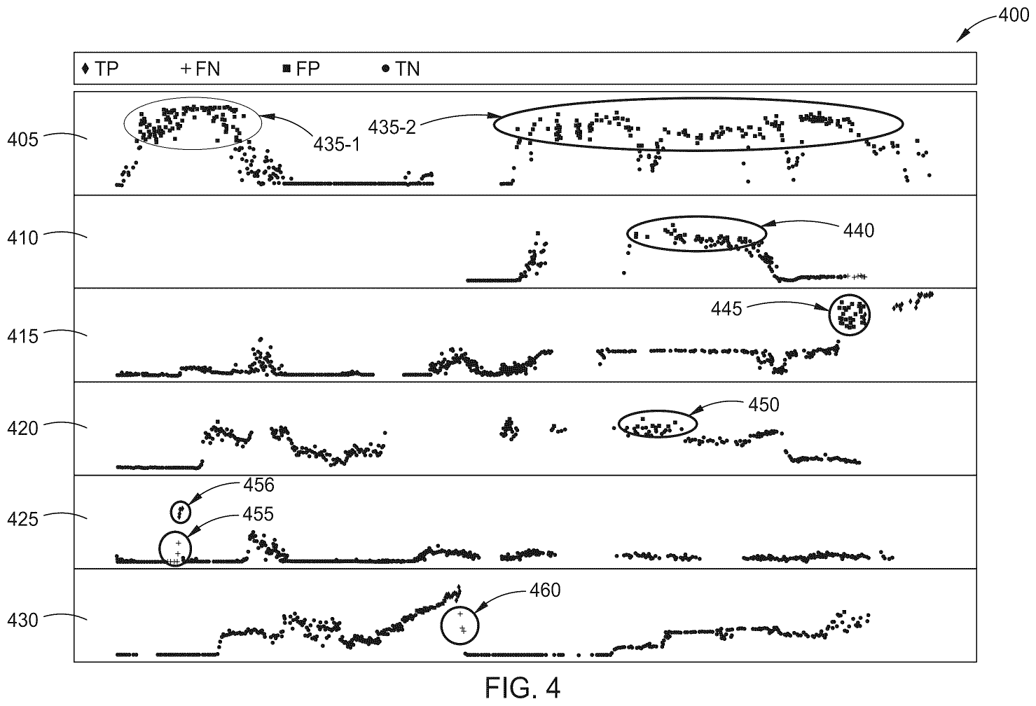

FIG. 4 depicts plots of aggregating flight-level predictions to generate alerts, according to one or more aspects. The features in FIG. 4 may be used in conjunction with other embodiments. For example, the different plots 405, 410, 415, 420, 425, 430 of diagram 400 represent different conditions for which alerts may be generated using the plurality of settings determined using the method 200 and/or method 300.

Plot 405 includes two groups 435-1, 435-2 of false positives (FP) within the fault probabilities generated by the predictive model 142. The group 435-1 is preceded by and followed by true negatives (TN) within the fault probabilities, and the group 435-2 has some true negatives interspersed therewith. Using the techniques described herein, the fault probabilities within each of the two groups 435-1, 435-2 may be aggregated using detection window(s) to reduce a number of generated alerts that (incorrectly) indicate a fault in the component.

Plot 410 includes a group 440 of false positives within the fault probabilities generated by the predictive model 142. The group 440 is followed by a set of true negatives and a set of false negatives (FN) within the fault probabilities. Using the techniques described herein, the fault probabilities within the group 440 may be aggregated using detection window(s) and may be given “partial credit” for providing an early prediction of the later set of false negatives (e.g., a reduced penalty for incorrectly indicating a fault in the component).

Plot 415 includes a group 445 of false positives within the fault probabilities generated by the predictive model 142. The group 445 is preceded by true negatives within the fault probabilities, and is followed by a set of true positives (TP). Using the techniques described herein, the fault probabilities within the group 440 may be aggregated using detection window(s) and may be given a reduced penalty for providing an early prediction of the later set of true positives.

Plot 420 includes a group 450 of false positives within the fault probabilities generated by the predictive model 142. The group 450 has a number of true negatives interspersed therewith. Using the techniques described herein, the fault probabilities within the group 450 may be aggregated using detection window(s) and may be effectively ignored.

Plot 425 includes a group 455 of false negatives within the fault probabilities generated by the predictive model 142. The group 455 is preceded by true negatives within the fault probabilities, and is followed by a group 456 of true positives before returning to true negatives. Using the techniques described herein, the fault probabilities within the group 455 may be aggregated using detection window(s) and may be given a reduced penalty due to providing an early prediction of the later set of true positives. For example, the false negatives of the group 455 do not generate alerts, but the true positives of the group 456 occurring later help to generate an alert.

Plot 430 includes a group 460 of false negatives within the fault probabilities generated by the predictive model 142. The group 460 is preceded by true negatives, false positives, and true positives within the fault probabilities, and is followed by true negatives. Using the techniques described herein, the fault probabilities within the group 460 may be aggregated using detection window(s) and may be given a reduced penalty for providing an early prediction of the later set of true negatives.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method comprising:
receiving flight sensor data and component fault data corresponding to a plurality of flights;
applying a predictive model to individual flights of the plurality of flights to generate a plurality of fault probabilities for at least one aircraft component;
selecting, based on a factor indicating a tolerance of false alerts, a plurality of settings comprising a minimum count of flights, a threshold probability, one or more detection window settings, and one or more alert group settings;
detecting, based on the one or more detection window settings, a condition that at least the minimum count of flights within a detection window have a respective fault probability, of the plurality of fault probabilities, that is greater than the threshold probability; and
determining, based on the one or more alert group settings, whether to generate a new alert for the condition.

2. The method of claim 1, further comprising:
determining, using inspection data, a count of false alerts for the aircraft component; and
selecting the factor using the count of false alerts.

3. The method of claim 1, further comprising:
receiving inspection data for the aircraft component,
wherein the plurality of settings further comprises one or more inspection settings, and
wherein determining whether to generate the new alert for the condition is based on the inspection data.

4. The method of claim 3, wherein determining whether to generate the new alert for the condition comprises:
when no previous alert exists for the aircraft component, generating an alert group and the new alert for the condition;
when a current runtime is within an inspection interval of a previous alert, awaiting an inspection result in the inspection data for the previous alert;
when an inspection result of the inspection data indicates that the aircraft component should be repaired or replaced, determining to not generate the new alert;
when the current runtime is at least a group gap setting after a time of the previous alert and a time of the inspection result, and a count of alert groups is less than a maximum group count, generating an alert group and the new alert for the condition; and
when a count of alerts in a current alert group is less than a group size, and the current runtime is at least a suppress windows setting that is based on the count of alerts, generating the new alert for the condition.

5. The method of claim 1, further comprising:
determining an optimal combination of the one or more detection window settings, which comprises, for individual combinations of a plurality of combinations:
for individual records of the flight sensor data and the component fault data, assigning arrival times to the individual records according to at least a first probability distribution;
simulating a plurality of iterations for the individual combination, each iteration comprising:
generating inspection data according to at least a second probability distribution; and
generating alerts based on the inspection data; and
determining the factor based on the generated alerts.

6. The method of claim 5, wherein the at least a first probability distribution comprises one or more of the following:
a probability distribution representing a generalized data delay; and
a probability distribution representing out-of-sequence data arrivals.

7. The method of claim 5, wherein the at least a second probability distribution comprises one or more of the following:
a probability distribution representing whether an inspection will be scheduled;
a probability distribution representing a time that the inspection will be scheduled;
a probability distribution representing whether the component will pass the inspection; and
a probability distribution representing a communication delay from the alerts.

8. A computer program product comprising:
a computer-readable storage medium having computer-readable program code embodied therewith, the computer-readable program code executable by one or more computer processors to perform an operation comprising:
receiving flight sensor data and component fault data corresponding to a plurality of flights;
applying a predictive model to individual flights of the plurality of flights to generate a plurality of fault probabilities for at least one aircraft component;
selecting, based on a factor indicating a tolerance of false alerts, a plurality of settings comprising a minimum count of flights, a threshold probability, one or more detection window settings, and one or more alert group settings;
detecting, based on the one or more detection window settings, a condition that at least the minimum count of flights within a detection window have a respective fault probability, of the plurality of fault probabilities, that is greater than the threshold probability; and
determining, based on the one or more alert group settings, whether to generate a new alert for the condition.

9. The computer program product of claim 8, the operation further comprising:
determining, using inspection data, a count of false alerts for the aircraft component; and
selecting the factor using the count of false alerts.

10. The computer program product of claim 8, the operation further comprising:
receiving inspection data for the aircraft component,
wherein the plurality of settings further comprises one or more inspection settings, and
wherein determining whether to generate the new alert for the condition is based on the inspection data.

11. The computer program product of claim 10, wherein determining whether to generate the new alert for the condition comprises:
when no previous alert exists for the aircraft component, generating an alert group and the new alert for the condition;
when a current runtime is within an inspection interval of a previous alert, awaiting an inspection result in the inspection data for the previous alert;
when an inspection result of the inspection data indicates that the aircraft component should be repaired or replaced, determining to not generate the new alert;
when the current runtime is at least a group gap setting after a time of the previous alert and a time of the inspection result, and a count of alert groups is less than a maximum group count, generating an alert group and the new alert for the condition; and
when a count of alerts in a current alert group is less than a group size, and the current runtime is at least a suppress windows setting that is based on the count of alerts, generating the new alert for the condition.

12. The computer program product of claim 8, the operation further comprising:
determining an optimal combination of the one or more detection window settings, which comprises, for individual combinations of a plurality of combinations:
for individual records of the flight sensor data and the component fault data, assigning arrival times to the individual records according to at least a first probability distribution;
simulating a plurality of iterations for the individual combination, each iteration comprising:
generating inspection data according to at least a second probability distribution; and
generating alerts based on the inspection data; and
determining the factor based on the generated alerts.

13. The computer program product of claim 12, wherein the at least a first probability distribution comprises one or more of the following:
a probability distribution representing a generalized data delay; and
a probability distribution representing out-of-sequence data arrivals.

14. The computer program product of claim 12, wherein the at least a second probability distribution comprises one or more of the following:
a probability distribution representing whether an inspection will be scheduled;
a probability distribution representing a time that the inspection will be scheduled;
a probability distribution representing whether the component will pass the inspection; and
a probability distribution representing a communication delay from the alerts.

15. A system comprising:
one or more processors; and
a memory storing instructions that when executed by the one or more processors enable performance of an operation comprising:
receiving flight sensor data and component fault data corresponding to a plurality of flights;
applying a predictive model to individual flights of the plurality of flights to generate a plurality of fault probabilities for at least one aircraft component;
selecting, based on a factor indicating a tolerance of false alerts, a plurality of settings comprising a minimum count of flights, a threshold probability, one or more detection window settings, and one or more alert group settings;
detecting, based on the one or more detection window settings, a condition that at least the minimum count of flights within a detection window have a respective fault probability, of the plurality of fault probabilities, that is greater than the threshold probability; and
determining, based on the one or more alert group settings, whether to generate a new alert for the condition.

16. The system of claim 15, the operation further comprising:
determining, using inspection data, a count of false alerts for the aircraft component; and
selecting the factor using the count of false alerts.

17. The system of claim 15, the operation further comprising:
receiving inspection data for the aircraft component,
wherein the plurality of settings further comprises one or more inspection settings, and
wherein determining whether to generate the new alert for the condition is based on the inspection data.

18. The system of claim 17, wherein determining whether to generate the new alert for the condition comprises:
when no previous alert exists for the aircraft component, generating an alert group and the new alert for the condition;
when a current runtime is within an inspection interval of a previous alert, awaiting an inspection result in the inspection data for the previous alert;
when an inspection result of the inspection data indicates that the aircraft component should be repaired or replaced, determining to not generate the new alert;
when the current run time is at least a group gap setting after a time of the previous alert and a time of the inspection result, and a count of alert groups is less than a maximum group count, generating an alert group and the new alert for the condition; and
when a count of alerts in a current alert group is less than a group size, and the current run time is at least a suppress windows setting that is based on the count of alerts, generating the new alert for the condition.

19. The system of claim 15, the operation further comprising:
determining an optimal combination of the one or more detection window settings, which comprises, for individual combinations of a plurality of combinations:
for individual records of the flight sensor data and the component fault data, assigning arrival times to the individual records according to at least a first probability distribution;
simulating a plurality of iterations for the individual combination, each iteration comprising:
generating inspection data according to at least a second probability distribution; and
generating alerts based on the inspection data; and
determining the factor based on the generated alerts.

20. The system of claim 19, wherein the at least a first probability distribution comprises one or more of the following:
a probability distribution representing a generalized data delay; and
a probability distribution representing out-of-sequence data arrivals.
